(19) United States
(12) Patent Application Publication
(10) Pub. No.: US 2026/0281871 A1
(43) Pub. Date: Sep. 17, 2026

(54) SYSTEMS AND METHODS FOR SATELLITE SERVICE ENTITLEMENT VERIFICATION

(71) Applicant: T-Mobile USA, Inc., Bellevue, WA (US)

(72) Inventors: Savitha Venkata Rao, Sammamish, WA (US); Nilesh Ranjan, Sammamish, WA (US)

(21) Appl. No.: 19/080,474

(22) Filed: Mar. 14, 2025

(51) Int. Cl. H04W 48/02; H04W 60/04; H04W 84/06

(52) U.S. Cl. CPC H04W 48/02; H04W 60/04; H04W 84/06

(57) ABSTRACT

System and methods for modifying terrestrial coverage devices to provide mobile network coverage using an entitlement server is described herein. An entitlement server is used to determine if the hardware/software configuration of a user equipment attempting to register with a satellite is approved. Before attempting to access a network through a satellite, in some examples, the user equipment can check to see if an entitlement certificate is stored thereon the user equipment. The entitlement certificate indicates that the network has already authorized access by the user equipment to satellite coverage. In some examples, the entitlement determination may be done while the user equipment is attempting to access the satellite. In these examples, when the user equipment transmits a registration request message to attempt to use the satellite of a mobile network, the mobile network determines if the user equipment is entitled to use the satellite.

### BACKGROUND

Telecommunications networks are increasing the use of satellites to augment network coverage across one or more areas. These satellites were often initially used in areas not covered by the networks terrestrial base stations but are increasingly being deployed in areas that may have some coverage provided by terrestrial base stations. Because of the transmission distance and sometimes slower transmission speeds between the cellular device and the satellite, the bandwidth provided by a satellite can be limited. Overloading a satellite's capacity by using more of a satellite's bandwidth than necessary can degrade the user experience of other user's connected to the network through the satellite. Especially in situations in which there is a high demand of services and capabilities, a satellite may not be able to provide the requested or required quality of service.

The presently disclosed subject matter is directed to aspects of improving the operation of a telecommunications networks using satellites.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a schematic diagram of an illustrative wireless communication network environment for determining satellite entitlement, in accordance with examples of the disclosure.

FIG. 2 is an example signal flow diagram for determining satellite entitlement, in accordance with examples of the disclosure.

FIG. 3 is a flow diagram of an illustrative process for determining satellite entitlement, in accordance with examples of the disclosure.

FIG. 4 is an example schematic diagram of an entitlement server, in accordance with examples of the disclosure.

FIG. 5 is an example schematic diagram of illustrative components in an example computing device, in accordance with examples of the disclosure.

### DETAILED DESCRIPTION

This disclosure is directed in part to systems and techniques for modifying terrestrial coverage for a user equipment using an entitlement server(ES). In some examples of the presently disclosed subject matter, a telecommunications network (or network) uses the ES to determine if a user equipment (UE) attempting to use a satellite to connect to the network has a minimum software version and hardware capability to be authorized (entitled) to use the satellite to connect to the network. In some examples, when a user registers a UE with the network, the network uses the ES to determine attributes of the UE. In these examples, when a UE is registered with a network, the network receives the software version and hardware capability of the UE at the ES. The ES accesses an equipment inventory registry (EIR) to receive information about the hardware capability of the UE. The ES further receives from the UE a software version of the operating system being used by the UE. Once the ES receives the hardware capability from the EIR, the ES verifies that the UE is entitled to access the satellite for network communications.

In some further examples of the presently disclosed subject matter, the ES or another component of the network, upon determining that the UE is entitled to access a satellite for network communication may generate an entitlement certificate and transmit that certificate to the UE. As noted above, because a satellite's bandwidth may be limited, having the satellite contact the network to determine if a UE attempting to access the satellite is entitled to do so may increase the use of the satellites bandwidth just to check to see if the UE is entitled to access the satellite. Therefore, in some examples of the presently disclosed subject matter, as part of the access procedure to access the satellite, the UE may also transmit the entitlement certificate to the satellite. The satellite receives the entitlement certificate and can verify that the UE is entitled to use the satellite without requiring the satellite to use additional bandwidth contacting the network for entitlement purposes. In some further examples, the UE may block attempts at accessing the satellite if the entitlement certificate is not stored on the UE. In these examples, additional bandwidth of the satellite may not be used for a process that would not be allowed, namely, a UE without an entitlement certificate attempting to register with the network through the satellite.

In some further examples, the ES receives subscription data from one or more network components to determine if the UE is entitled to use the satellite. For example, the UE may be a device associated with a subscription plan that gives the UE access to satellite coverage. In another example, the UE may be a device associated with a subscription that doesn't give the UE access to satellite coverage. In a still further example, the UE may be a device associated with a subscription that gives tiered or prioritized access to a satellite in relation to other devices associated with other subscriptions. For example, a subscription may be available that allows access to a satellite if the satellite usage (bandwidth) is below a predetermined maximum for that subscription plan. Thus, even if the UE would otherwise be entitled to the satellite based on the hardware and software version of the UE, if the satellite usage is above the predetermined maximum for the subscription plan, the UE may not be granted access to the satellite.

In still further examples, the UE may have its access revoked in some circumstances. Continuing with the subscription example provided above, a UE may be using a satellite after access is granted based on the software/hardware and subscription plan of the UE. However, another UE, such as a UE used by a first responder or other emergency management entity, may enter the coverage area of the satellite and request access to the satellite. The entering UE may have a subscription plan that grants the UE a higher level of access than the UE currently using the satellite. If the entering UE is granted access to the satellite, the usage of the satellite may increase to a level above the predetermined maximum for the subscription plan for the UE currently accessing the satellite. Thus, in this example, the satellite may cease access to the satellite of the current UE to allow the entering UE to access the satellite. In another example, the satellite may allow the UE currently using the satellite to remain using the satellite until a viable alternative base station (such as a terrestrial base station or another satellite) becomes available, and then transfer that UE to the alternative base station.

The systems and methods discussed herein are discussed generally with respect to cellular UEs, tablets, computers, and the like, and in terms of components (e.g., network entities) associated with Wi-Fi networks, Bluetooth networks, wired networks, fourth generation (4G) and fifth generation (5G) cellular networks using terrestrial and satellite base stations, and other types of networks. The systems and methods can be used with other types of equipment and on other types of networks, however, where users may wish to have increased flexibility in sending and receiving calls, video calls, and messages. Thus, the systems and methods described herein are described in terms of 4G or 5G networks merely because these networks represent the state of the current art. One of skill in the art will recognize, however, the systems and methods could also be used on other networks that provide video calling such as, for example, Internet of Things (IoT), machine-to-machine (M2M), sixth generation (6G), and other current and future networks.

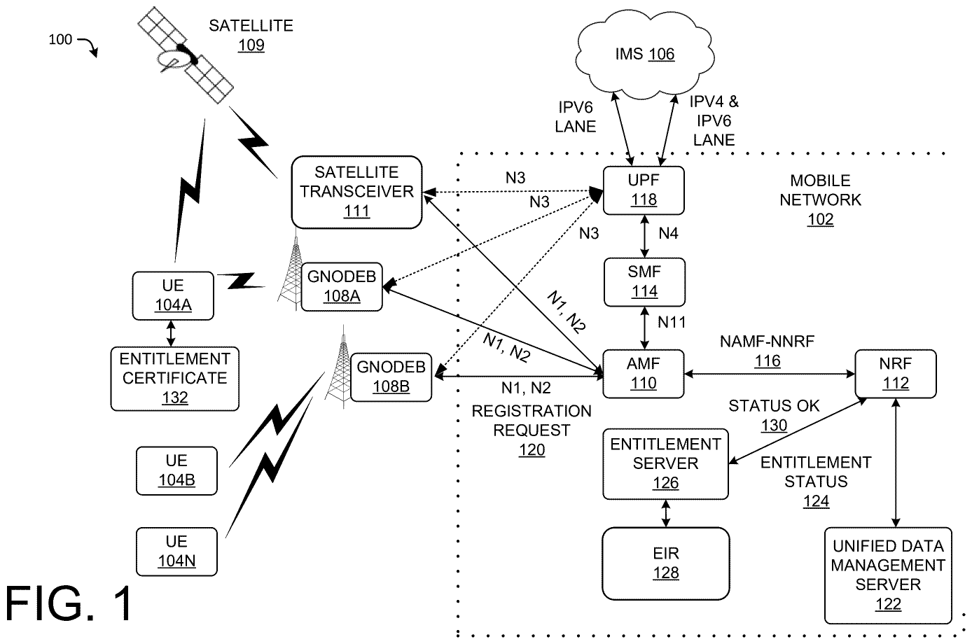

FIG. 1 is a schematic diagram of an illustrative wireless network environment 100 in which the disclosed systems and techniques may be implemented, in accordance with examples of the disclosure. The environment 100 may include a mobile network 102. The mobile network 102 may include various types of networks that support the communication of one or more user equipment 104A-104N (hereinafter referred to generically and collectively as “the UE 104,” and individually as “the UE 104A,” “the UE 104B,” and “the UE 104N”) using the mobile network 102. It should be noted that although the UE 104 are illustrated as having wireless connections, the UE 104 may be wired and wireless, and may also be part of a network such as an enterprise network (not shown). The UE 104 may be devices such as computer, mobile cellular phones, cellular home Internet devices, and the like. The mobile network 102 may be one or more mobile telecommunication networks that facilitate communications between devices of various types, such as computing device and mobile devices (e.g., UEs). Various connections between devices in the mobile network 102 may be wired, wireless, or a combination thereof. The mobile network 102 may facilitate packet-based communications between the UE 104 and devices on the Internet and/or one or more Internet Protocol Multimedia Systems (IMSs), such as IP multimedia system or subsystem (IMS) 106.

The mobile network 102 may include networks that support one or more 3GPP standards, including, but not limited to, Long Term Evolution (LTE) networks (e.g., 4G LTE networks) and New Radio (NR) networks (e.g., 5G NR networks). However, the disclosed systems and techniques may be applicable in any network or system in which the UE 104 may request and receive access to communicate with network and/or remote devices using any protocol. A UE 104 may access the IMS 106 using protocols such as IPv4 and IPv6. A request for an IPv4v6 communications connection from the device (also known as a “dual stack” connection) may indicate that the UE 104 supports both IPv4 and IPv6. Such a UE 104 may prefer to use IPv6 but is able to use IPv4 in the event that an IPv6 connection is not available.

Communication between the UE 104 and the mobile network 102 may be provided through the use of one or more base stations, represented in FIG. 1 by gNodeB 108A and 108B (hereinafter referred to generically as “the gNodeB 108,” and individually as “the gNodeB 108A” and “the gNodeB 108B”). While referred to as a “gNodeB” for explanatory purpose herein, the gNodeB 108 may be any type of base station, including, but not limited to, any type of base transceiver station (BTS), NodeB, eNodeB, gNodeB, and the like. The gNodeB 108 may communicate with other devices and elements in the core of the mobile network 102. The gNodeB 108 is an example of an asset that is installed at a fixed or relatively fixed geographic location to service the UE 104 in the cell provided by the gNodeB 108. Communications between the UE 104 and the mobile network 102 may also be provided by satellite 109. The satellite 109 may be configured to act as a base station, such as the gNodeB 108, or may be configured with additional capabilities. The presently disclosed subject matter is not limited to any particular configuration of the satellite 109. In the example illustrated in FIG. 1, the UE 104B and the UE 104N are being serviced by the gNodeB 108B, while the UE 104A is being serviced by the satellite 109 through a satellite transceiver 111. It should be noted that the satellite 109 may communicate with the mobile network 102 using technologies other than the satellite transceiver 111.

Once the UE 104 has been registered with the mobile network 102, either through the gNodeB 108 or the satellite 109, the UE 104 can access services provided by the IMS 106 through the gNodeB 108 or the satellite 109 by establishing a protocol data unit (PDU) session at the mobile network 102. A PDU session, for example in a 5G network, may be an end-to-end communications session between a device (e.g., the UE 104) and a data network (e.g., the IMS 106). The gNodeB 108 or the satellite 109 may relay or otherwise convey this PDU session request from the UE 104 to an access management function (AMF) 110 in the core of the wireless network in which the gNodeB108 or the satellite 109 is configured. The AMF 110 may interact with one or more other components to perform the operations needed to establish this session, such as authenticating the device and/or user, registering the UE 104 with the mobile network 102.

The AMF 110, based on receiving this request for the establishment of a PDU, i.e., an IPv4-type or IPv6-type session on behalf of the UE 104, may query a new radio function (NRF) 112 for an address (e.g., IP address) for a session management function (SMF) 114 with which it may interact to establish the requested PDU session. The AMF 110 may exchange SMF discovery communications 116 (Namf-Nnrf), which may be called an SMF address request in some examples, with the NRF 112. The NRF 112 returns the identifier of the SMF 114 for use by the AMF 110. Thereafter, the AMF 110 sends a connection request N11 to the selected SMF 114. In examples, the SMF 114 may provide the access information needed by the UE 104 to communicate with a data network using the established session.

The SMF 114 provides this information to the AMF 110 for relay to the gNodeB 108 or the satellite 109 and ultimately to the UE 104 requesting the PDU session. In 5G examples, a message that provides such information may be referred to as a “N1N2MessageTransfer.” These and other messages communicating similar information may be referred to generally herein as a “message transfer” messages. The SMF 114 further establishes a connection to its coordinating user plane function (UPF) 118 through an N4 interface, which facilitates communications between the UE 104 and the IMS 106. The SMF 114 generates a connection N3 from the gNodeB 108 or the satellite 109 to the UPF 118 to provide a communication path between the UE 104, through the gNodeB 108 or the satellite 109, and to and from the IMS 106 through either the IPv6 or the IPv4&IPv6 lane.

As noted above, the satellite may have limited bandwidth available to service one or more of the UE 104 in the coverage area of the satellite. Further, the mobile network 102 may be configured so that only UEs 104 with the permitted/required hardware/software versions are allowed to access the satellite 109. Thus, before a UE, such as the UE 104A, is permitted to access the mobile network 102 using the satellite 109, upon receiving a registration request from the UE 104A to use the satellite 109, the NRF 112 transmits a query to a unified data management server (UDM) 122. In a 5G network, the UDM 122 acts as a centralized database that stores user data for a network. It should be noted that the use of the UDM 122 is merely by way of example, as the functionality of the UDM 122 as presently disclosed may be provided in other manners in different network configurations, such as a home location register (HLR) in other types of networks. This user data includes information about the users as well as other data such as subscription plans. The NRF 112 queries the UDM 122 to determine if the UE 104A is associated with a subscription plan that authorizes the use of the satellite 109. If the UE 104A is associated with a subscription plan that authorizes the use of the satellite 109, the NRF 112 transmits an entitlement status 124 to an entitlement server(ES) 126.

The entitlement status 124 comprises a request from the NRF 112 as to whether or not the UE 104A is entitled to use the satellite 109 based on the software/hardware associated with the UE 104A. Upon receiving the entitlement status 124 from the NRF 112, the ES 126 queries an equipment identity register (EIR) 128 to receive information about the hardware/software associated with the UE 104A. The ES 126 receives the information about the hardware/software associated with the UE 104A and determines, based on the that information, if the UE 104A is entitled to use the satellite 109. If the ES 126 determines that the UE 104A is entitled to use the satellite 109, the ES 126 transmits status OK message 130 to the NRF 112, signifying that the UE 104A is entitled to use the satellite 109.

As noted above, in some examples, the entitlement process may be generated by the satellite 109 when the UE 104A transmits a registration request 120 to the satellite 109 or otherwise requests the use of the satellite 109. This process may use a significant portion of the bandwidth made available by the satellite 109, especially during times in which more than one UE 104 may be requesting registration. To reduce bandwidth usage, an entitlement certificate 132 may be stored on the UE 104A. The entitlement certificate 132 is a certificate that indicates that the entitlement process has already been completed for the UE 104A and that the UE 104A is entitled to use the satellite 109. The entitlement certificate 132 may be updated based on various factors, such as software/hardware updates made to the UE 104A, changes to the subscription plan to which the UE 104A is associated, and the like. When transmitting a registration request 120, the satellite 109 may receive the entitlement certificate 132 and move forward with the registration process. In some examples, if the satellite does not receive the entitlement certificate 132, the satellite 109 can inform the mobile network 102 of the lack of the entitlement certificate 132, whereby the mobile network 102 can proceed with the entitlement process as described above using the entitlement server 126.

In some examples, access to the satellite 109 may be limited based on the current (bandwidth) usage or availability of the satellite 109. In some examples, the UE 104A may be associated with a subscription that allows access to the satellite 109 if the usage of the satellite is at or below a predetermined subscription threshold. For example, the subscription threshold may be fifty percent (50%), meaning if the satellite is above 50% usage (based on the capabilities of the satellite 109), even if entitled to use the satellite 109 based on the hardware/software of the UE 104A, the UE 104A will not be registered with the satellite 109. The NRF 112, or another component of the mobile network 102, will transmit a deny message in response to the registration request 120. In another example, if the satellite is at or below 50% usage (based on the capabilities of the satellite 109), if entitled to use the satellite 109 based on the hardware/software of the UE 104A, the UE 104A will be registered with the satellite 109. The NRF 112, or another component of the mobile network 102, will transmit an acceptance message in response to the registration request 120.

In another example described above, UE 104A may have its access to the satellite 109 revoked in some circumstances. The UE 104A may be using the satellite 109 after access is granted based on the software/hardware and subscription plan of the UE 104A. The UE 104A may be associated with a subscription that gives the UE 104A a lower priority of access than UEs 104 associate with subscriptions with a relatively higher priority of access. In the current example, the UE 104A is associated with a low priority of access, meaning UEs, such as the UE 104B, with a relatively higher priority access requesting access to the satellite can cause the satellite 109 to initiate a transfer of the UE 104A to another base station, such as the gNodeB 108A/108B. Upon receiving a registration request from the UE 104B, the satellite 109 or the NRF 112 can determine if the satellite 109 has enough bandwidth to support the UE 104B.

If there is enough bandwidth to support the UE 104B without removing the UE 104A, the UE 104B may be registered without any change to the status of the UE 104A. However, if adding the UE 104B will cause bandwidth issues or increase the bandwidth usage of the satellite 109 beyond the maximum threshold allowed by the subscription associated with the UE 104A, the satellite 109 may notify the NRF 112 (or another component of the mobile network 102 may generate a notice) that the access of the UE 104A to the satellite 109 is to be removed. The NRF 112 then queries other base stations or satellites to determine if the UE 104A may be transferred without a service interruption. In some examples, depending on the location and direction of travel of the UE 104A, the NRF 112 may temporarily halt the transfer of the UE 104A to another base station until the UE 104A is within the coverage area of that alternative base station. Upon determining that all or a portion of the workload of the satellite 109 for the UE 104A may be shifted to the gNodeB 108A if the gNodeB 108B is reconfigured, the NRF 112 sends configuration changes to the gNodeB 108A to allow the gNodeB 108A to commence servicing the UE 104A. Once reconfigured, the gNodeB 108A transmits a service broadcast and, if received by the UE 104A, the UE 104A commences the registration process with the gNodeB 108A to allow the gNodeB 108A to commence or take over the workload of the UE 104A from the satellite 109. It should be noted, however, that in some examples the UE 104A may simply be dropped from being serviced by the satellite 109.

### Illustrative Signal Flows

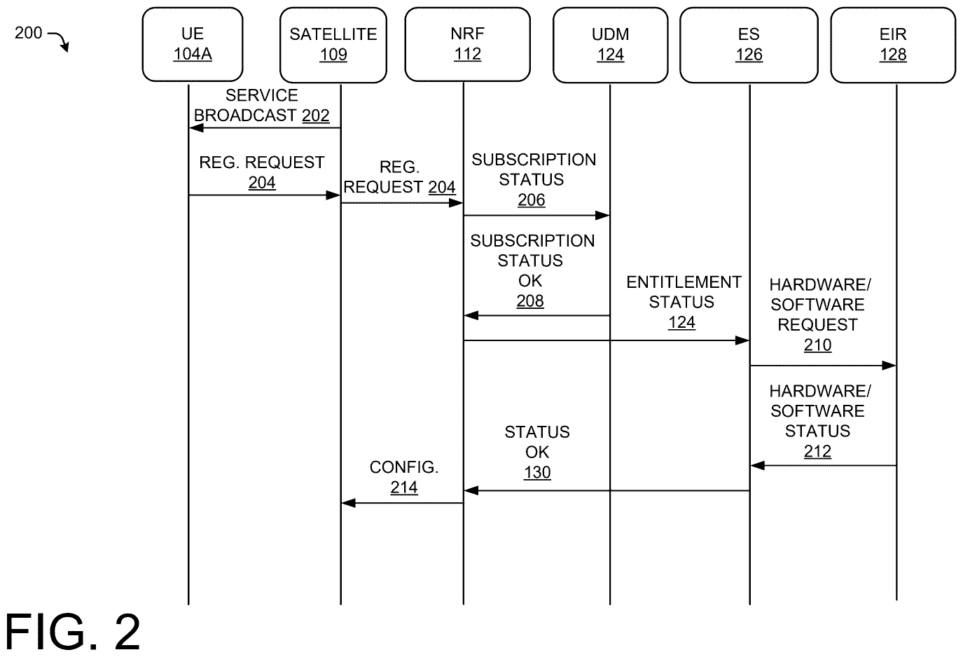

FIG. 2 illustrates an exemplary signal flow 200 of various messages that may be exchanged in one or more of the disclosed systems and techniques for modifying terrestrial coverage for a user equipment using the entitlement server 126, in accordance with examples of the disclosure. Reference may be made in this description of the signal flow 200 to devices, entities, and interfaces illustrated in FIG. 1 and described in regard to that figure. However, the operations, signals, and signal flow illustrated in FIG. 2 and described herein may be implemented in any suitable system and/or with any one or more suitable devices and/or entities. Moreover, any of the operations, signals, and/or entities described in regard to FIG. 2 may be used separately and/or in conjunction with other operations, signals, and/or entities. All such embodiments are contemplated as within the scope of the instant disclosure.

In FIG. 2, the satellite 109, acting as a potential base station in a manner similar to the gNodeBs 108, transmits a service broadcast 202 to the coverage area of the satellite 109. The coverage area of the satellite 109 may be limited to a particular area or may be dependent on the power of the satellite 109. The presently disclosed subject matter is not limited to any particular manner in which the coverage area of the satellite 109 is determined. The UE 104A receives the service broadcast 202 and, if desiring to use the satellite 109 for access to the mobile network 102, commences a registration process by transmitting a registration request 204 to the satellite 109, which is in turn transmitted to the NRF 112. Prior to allowing the UE 104A to access and use the satellite 109, the entitlement to use the satellite 109 is determined. The NRF 112 first checks the subscription status of the UE 104A to determine if the UE 104A is allowed to use the satellite 109. The NRF 112 transmits a subscription status 206 message to the UDM 122 to confirm that the UE 104A subscription allows for satellite use. If the subscription does, the UDM 122 transmits a subscription status OK 208 message to the NRF 112. If the subscription does not, the UDM 122 doesn't transmit the subscription status OK 208 message to the NRF 112 or transmits another message indicating that the subscription does not allow for satellite use.

Upon receiving the subscription status OK 208 message, the NRF 112 then checks to see if the current hardware/software configuration of the UE 104A is permissible to use the satellite 109. The NRF 112 transmits the entitlement status 124 message to the ES 126. The ES 126 transmits a hardware/software request 210 message to the EIR 128. The EIR 128 accesses a datastore and returns the hardware/software configuration of the UE 104A to the ES 126 using a hardware/software status 212 message. The hardware/software status 212 message includes software versions being used on the UE 104A as well the hardware. The ES 126 uses the information received in the hardware/software status 212 message to determine if the UE 104A is entitled to use the satellite 109. Upon determining that the UE 104A is entitled to use the satellite 109, the ES 126 transmits the status OK 130 message to the NRF 112. The NRF 112, upon receiving the status OK 130 message, transmits a configuration 214 message to the satellite 109 to configure the satellite 109 to continue the registration process of the UE 104A. It should be noted that, as discussed above, the entitlement process may be performed in advance whereby a certificate of entitlement is stored on the UE 104A. When the UE 104A transmits the registration request 204 message, the satellite 109 or another entity of the mobile network 102 may request or receive the entitlement certificate indicating that the UE 104A has been preapproved for satellite coverage.

### Illustrative Operations

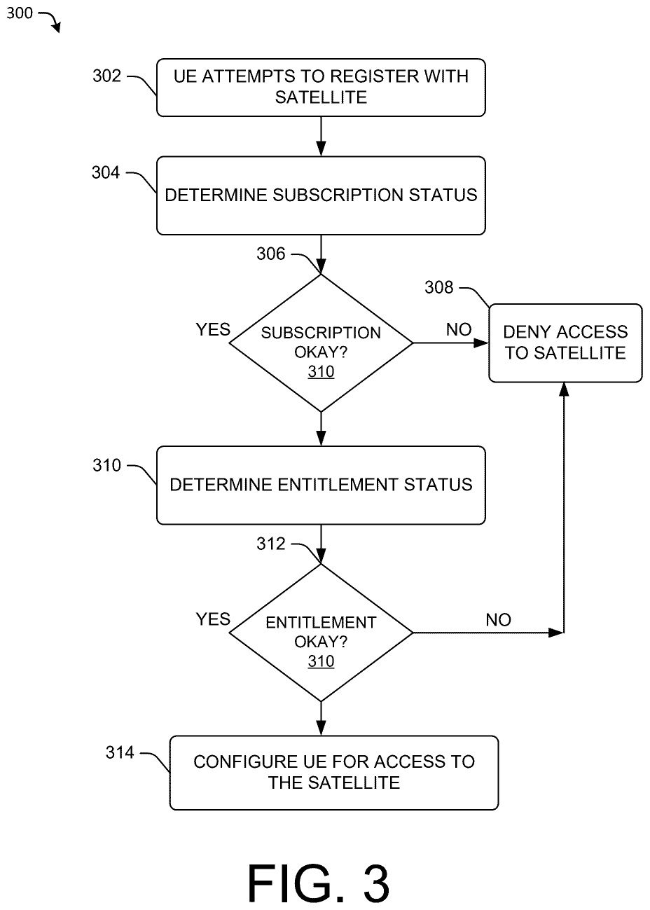

FIG. 3 shows a flow diagram of an illustrative process 300 for modifying terrestrial coverage for a user equipment using an entitlement server(ES), in accordance with examples of the disclosure. The process 300 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 300 may be described with reference to the wireless network environment 100 of FIG. 1, however other environments may also be used.

At block 302, the UE 104A attempts to register with the satellite 109 by transmitting a registration request 204 to the satellite 109. Because access to the satellite 109 may be limited to specific UEs for various reasons, the mobile network 102 may only allow entitled UEs to access the satellite using the entitlement server 126. Determining whether or not the UE 104A is entitled to use the satellite 109 involves an entitlement process. As noted above, the UE 104A may perform a determination operation prior to block 302. For example, the UE 104A may determine if an entitlement certificate is stored thereon. If the entitlement certificate is not stored on the UE 104A, the UE 104A may not attempt to access the satellite 109, and thus, the process 300 may not commence.

At block 304, the mobile network 102 determines if the UE 104A has a subscription to use the satellite 109. A subscription server, such as the UDM 122, is accessed to retrieve subscription data for the account associated with the UE 104A. As noted above, the UE 104A may perform the operation of block 304. For example, the UE 104A may determine if an entitlement certificate is stored thereon. If the entitlement certificate is not stored on the UE 104A, the UE 104A may not attempt to access the satellite 109.

At block 306, the mobile network 102 determines if the subscription is okay. The subscription may be a binary allowed/not-allowed subscription, or may include various levels of access. For example, as described above, in some examples, access to the satellite 109 may be limited based on the current (bandwidth) usage or availability of the satellite 109. In some examples, the UE 104A may be associated with a subscription that allows access to the satellite 109 if the usage of the satellite is at or below a predetermined subscription threshold. For example, the subscription threshold may be fifty percent (50%), meaning if the satellite is above 50% usage (based on the capabilities of the satellite 109), even if entitled to use the satellite 109 based on the hardware/software of the UE 104A, the UE 104A will not be registered with the satellite 109. The NRF 112, or another component of the mobile network 102, will transmit a deny message in response to the registration request 120. In another example, if the satellite is at or below 50% usage (based on the capabilities of the satellite 109), if entitled to use the satellite 109 based on the hardware/software of the UE 104A, the UE 104A will be registered with the satellite 109. The NRF 112, or another component of the mobile network 102, will transmit an acceptance message in response to the registration request 120.

In another example, UE 104A may have its access to the satellite 109 revoked in some circumstances. The UE 104A may be using the satellite 109 after access is granted based on the software/hardware and subscription plan of the UE 104A. The UE 104A may be associated with a subscription that gives the UE 104A a lower priority of access than UEs 104 associate with subscriptions with a relatively higher priority of access. In the current example, the UE 104A is associated with a low priority of access, meaning UEs, such as the UE 104B, with a relatively higher priority access requesting access to the satellite can cause the satellite 109 to initiate a transfer of the UE 104A to another base station, such as the gNodeB 108A/108B. Upon receiving a registration request from the UE 104B, the satellite 109 or the NRF 112 can determine if the satellite 109 has enough bandwidth to support the UE 104B.

If at block 306 the mobile network 102 determines that the subscription is not okay, meaning that based on the subscription the UE 104A is not permitted to access the satellite 109, at block 308 the UE 104A is denied access to the satellite 109. In some examples, this may mean that the UE 104A may be without coverage due to a lack of terrestrial base stations, or in other instances, may be registered with one of the terrestrial base stations providing coverage in the area of the UE 104A.

If at block 306 the mobile network 102 determines that the subscription is okay, meaning that based on the subscription the UE 104A may be permitted to access the satellite 109, the process 300 continues to block 310, where the mobile network 102 commences the entitlement determination process. The ES 126 queries the EIR 128 to determine the hardware/software configuration of the UE 104A.

At block 312, the ES 126 determines whether or not the entitlement is okay based on the hardware/software configuration of the UE 104A. For example, if the software version being used by the UE 104A is a least a specific version, the hardware installed allows communication with the satellite 109, and there is no unauthorized hardware/software being used on the UE 104A for the purposes of entitlement, the ES 126 can determine that the UE 104A is entitled to use the satellite 109.

At block 312, if the ES 126 determines that the UE 104A is not entitled to use the satellite 109, the process 300 continues to block 308 where the UE 104A is denied access to the satellite. At block 312, if the ES 126 determines that the UE 104A is entitled to use the satellite 109, the process 300 continues to block 314 where the mobile network 102 configures the UE 104A and the satellite 109 to allow the UE 104A to use the satellite 109.

### Example User Equipment

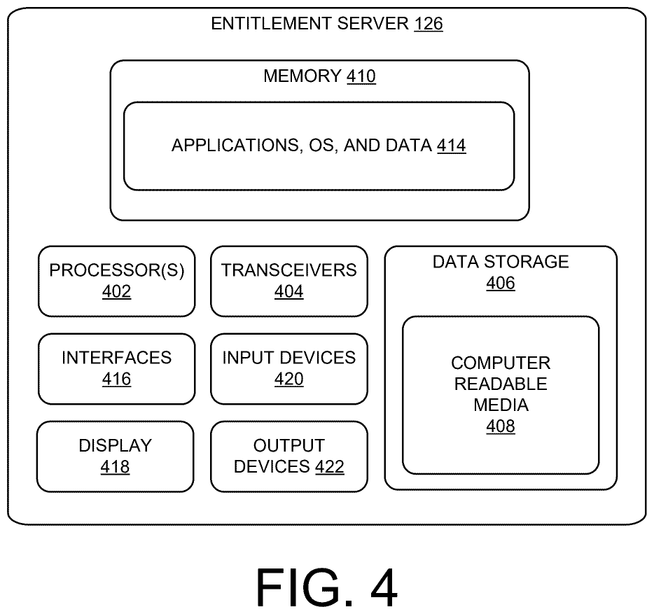

FIG. 4 is an example of the entitlement server 126 for use with the systems and methods disclosed herein, in accordance with some examples of the present disclosure. The entitlement server 126 may include one or more processors 402, one or more transmit/receive antennas (e.g., transceivers or transceiver antennas) 404, and a data storage 406. The data storage 406 may include a computer readable media 408 in the form of memory and/or cache. This computer-readable media may include a non-transitory computer-readable media. The processor(s) 402 may be configured to execute instructions, which can be stored in the computer readable media 408 and/or in other computer readable media accessible to the processor(s) 402. In some configurations, the processor(s) 402 is a Central Processing Unit (CPU), a Graphics Processing Unit (GPU), or both CPU and GPU, or any other sort of processing unit. The transceiver antenna(s) 404 can exchange signals with a base station, such as gNodeB 108, or a satellite such as the satellite 109.

The entitlement server 126 may be configured with a memory 410. The memory 410 may be used to store the hardware/software configuration of the UE 104A received from the EIR 128 and a copy of the entitlement certificate 132. The memory 410 may be implemented within, or separate from, the data storage 406 and/or the computer readable media 408. The memory 410 may include any available physical media accessible by a computing device to implement the instructions stored thereon. For example, the memory 410 may include, but is not limited to, RAM, ROM, EEPROM, a SIM card, flash memory or other memory technology, CD-ROM, DVD or other optical disk storage, magnetic cassettes, magnetic tape, magnetic disk storage or other magnetic storage devices, or any other medium which may be used to store the desired information.

The memory 410 can store several modules, such as instructions, data stores, and so forth that are configured to execute on the processor(s) 402. In configurations, the memory 410 may also store one or more applications 414 configured to receive and/or provide voice, data and messages (e.g., SMS messages, Multi-Media Message Service (MMS) messages, Instant Messaging (IM) messages, Enhanced Message Service (EMS) messages, etc.) to and/or from another device or component (e.g., the gNodeB 108). The applications 414 may further include applications to determine if the mobile network 102 is to be reconfigured. The applications 414 may also include one or more operating systems and/or one or more third-party applications that provide additional functionality to the ES 126.

Although not all illustrated in FIG. 4, the entitlement server 126 may also comprise various other components, e.g., a battery, a charging unit, one or more network interfaces 416, an audio interface, a display 418, a keypad or keyboard, and one or more input devices 420, and one or more output devices 422.

### Example Computing Device

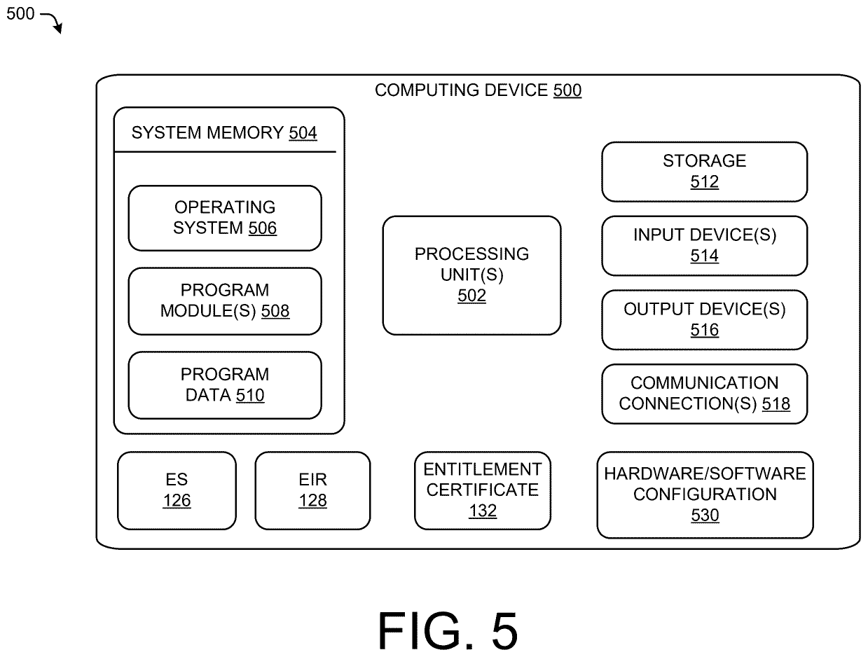

FIG. 5 is an example schematic of a computing device 500 for use with the systems and methods disclosed herein, in accordance with some examples of the present disclosure. The computing device 500 can be used to implement various components of a core network, a base station, and/or any servers, routers, gateways, gateway elements, administrative components, etc. that can be used by a communication provider. The computing device 500 can further be used to implement the mobile network 102, the ES 126, the EIR 128, and other components of the mobile network 102.

In various embodiments, the computing device 500 can include one or more processing units 502 and system memory 504. Depending on the exact configuration and type of computing device, the system memory 504 can be volatile (such as RAM), non-volatile (such as ROM, flash memory, etc.) or some combination of the two. The system memory 504 can include an operating system 506, one or more program modules 508, and can include program data 510. The system memory 504 may be secure storage or at least a portion of the system memory 504 can include secure storage. The secure storage can prevent unauthorized access to data stored in the secure storage. For example, data stored in the secure storage can be encrypted or accessed via a security key and/or password. The program modules can include instructions to execute the ES 126, the EIR 128, and other components of the mobile network 102 of FIG. 1.

The computing device 500 can also include additional data storage devices (removable and/or non-removable) such as, for example, magnetic disks, optical disks, or tape. Such additional storage is illustrated in FIG. 5 by storage 512.

Non-transitory computer storage media of the computing device 500 can include volatile and nonvolatile, removable and non-removable media implemented in any method or technology for storage of information, such as computer readable instructions, data structures, program modules, or other data such as the hardware/software configuration 530 of the UE 104A received from the EIR 128. The system memory 504 and storage 512 are examples of computer readable storage media. Non-transitory computer readable storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information, and which can be accessed by computing device 500. Any such non-transitory computer readable storage media can be part of the computing device 500.

In various embodiments, any or all of the system memory 504 and storage 512 can store programming instructions which, when executed, implement some or all of the functionality described above as being implemented by one or more systems configured in the environment 100 and/or components of the mobile network 102.

The computing device 500 can also have one or more input devices 514 such as a keyboard, a mouse, a touch-sensitive display, voice input device, etc. The computing device 500 can also have one or more output devices 516 such as a display, speakers, a printer, etc. can also be included. The computing device 500 can also contain one or more communication connections 518 that allow the device to communicate with other computing devices using wired and/or wireless communications, including, but not limited to, the satellite transceiver 111.

### EXAMPLE CLAUSES

The following paragraphs describe various examples. Any of the examples in this section may be used in combination(s) with any other of the examples in this section and/or any of the other examples or embodiments described herein.

A: All methods, systems, and apparatuses, including all equivalents and combinations, disclosed herein, as well as the following example clauses in various combinations.

Clause 1. A method, comprising: receiving, at a mobile network, a registration request of a user equipment (UE) requesting access to a satellite used for communication by the mobile network, wherein the UE has stored thereon an entitlement certificate, the entitlement certificate generated by; determining, by the mobile network, that a subscription associated with the UE permits access to the satellite; commencing, by an entitlement server, an entitlement process to determine if the UE is entitled to access the satellite; and upon determining that the UE is entitled to access the satellite, commencing configuring the UE for communicating with the satellite, or, upon determining that the UE is not entitled to access the satellite, denying access of the UE to the satellite.

Clause 2. The method of clause 1, wherein determining by the mobile network, that the subscription associated with the UE permits access to the satellite comprises determining that the subscription includes satellite access.

Clause 3. The method of clause 1, wherein determining by the mobile network, that the subscription associated with the UE permits access to the satellite comprises: receiving a maximum usage level of the satellite of which the UE is allowed to access the satellite; receiving a current usage level of the satellite; and determining that that the current usage level of the satellite is at or lower than the maximum usage level of the satellite.

Clause 4. The method of clause 1, further comprising revoking access of the UE to the satellite following the determining that the UE is entitled to access the satellite.

Clause 5. The method of clause 4, wherein revoking access of the UE to the satellite comprises: receiving, at the mobile network, a registration request of a second UE requesting access to the satellite; determining by the mobile network, that the subscription associated with the UE is a lower priority access than a second subscription associated with the second UE; and removing access of the UE to the satellite by transferring coverage of the UE to a base station or dropping satellite coverage of the UE.

Clause 6. The method of clause 5, wherein the second UE is a device used by a first responder.

Clause 7. The method of clause 1, further comprising generating an entitlement certificate upon the determining that the UE is entitled to access the satellite, wherein the entitlement certificate is transmitted to the satellite indicating that the UE is entitled to access the satellite.

Clause 8. The method of clause 7, further comprising updating, by the entitlement server, the entitlement certificate upon receiving an update of a hardware/software configuration of the UE.

Clause 9. The method of clause 1, wherein the entitlement process comprises: querying an equipment inventory register for a hardware/software configuration of the UE; receiving, by the entitlement server, the hardware/software configuration of the UE; and determining an entitlement status of the UE based on the hardware/software configuration of the UE.

Clause 10. A non-transitory computer-readable media storing computer-executable instructions that, when executed by one or more processors, cause the one or more processors to perform operations comprising: receiving, at a mobile network, a registration request of a user equipment (UE) requesting access to a satellite used for communication by the mobile network; determining, by the mobile network, that a subscription associated with the UE permits access to the satellite; and commencing, by an entitlement server, an entitlement process to determine if the UE is entitled to access the satellite, the entitlement process comprising: determining an entitlement status of the UE based on a hardware/software configuration of the UE; and upon determining that the entitlement status is okay, commencing configuring the UE for communicating with the satellite, or, upon determining that the entitlement status is not okay, denying access of the UE to the satellite.

Clause 11. The non-transitory computer-readable media of clause 10, wherein the computer-executable instructions that, when executed by the one or more processors, cause the one or more processors to perform operations comprising determining by the mobile network, that the subscription associated with the UE permits access to the satellite computer-executable instructions that, when executed by the one or more processors, cause the one or more processors to perform operations comprising determining that the subscription includes satellite access.

Clause 12. The non-transitory computer-readable media of clause 10, wherein the computer-executable instructions that, when executed by the one or more processors, cause the one or more processors to perform operations comprising determining by the mobile network, that the subscription associated with the UE permits access to the satellite further comprises computer-executable instructions that, when executed by the one or more processors, cause the one or more processors to perform operations comprising: receiving a maximum usage level of the satellite of which the UE is allowed to access the satellite; receiving a current usage level of the satellite; and determining that that the current usage level of the satellite is at or lower than the maximum usage level of the satellite.

Clause 13. The non-transitory computer-readable media of clause 10, further comprising revoking access of the UE to the satellite following the determining that the entitlement status is okay.

Clause 14. The non-transitory computer-readable media of clause 13, wherein the computer-executable instructions that, when executed by the one or more processors, cause the one or more processors to perform operations comprising revoking access of the UE to the satellite further comprises computer-executable instructions that, when executed by the one or more processors, cause the one or more processors to perform operations comprising: receiving, at the mobile network, a registration request of a second UE requesting access to the satellite; determining by the mobile network, that the subscription associated with the UE is a lower priority access than a second subscription associated with the second UE; and removing access of the UE to the satellite by transferring coverage of the UE to a base station or dropping satellite coverage of the UE.

Clause 15. The non-transitory computer-readable media of clause 10, further comprising computer-executable instructions that, when executed by the one or more processors, cause the one or more processors to perform operations comprising generating an entitlement certificate, wherein the entitlement certificate is transmitted to the satellite indicating that the UE is entitled to access the satellite.

Clause 16. The non-transitory computer-readable media of clause 15, further comprising computer-executable instructions that, when executed by the one or more processors, cause the one or more processors to perform operations comprising updating, by the entitlement server, the entitlement certificate upon receiving an update of the configuration of the UE.

Clause 17. The non-transitory computer-readable media of clause 10, wherein the entitlement process further comprises: querying an equipment inventory register for the hardware/software configuration of the UE; and receiving, by the entitlement server, the hardware/software configuration of the UE.

Clause 18. A network, comprising: a memory storing computer-executable instructions; and one or more processors in communication with the memory, the computer-executable instructions causing the processor to perform acts comprising: receiving, at a mobile network, a registration request of a user equipment (UE) requesting access to a satellite used for communication by the mobile network; determining, by the mobile network, that a subscription associated with the UE permits access to the satellite; commencing, by an entitlement server, an entitlement process to determine if the UE is entitled to access the satellite, the process comprising: querying an equipment inventory register for a hardware/software configuration of the UE; receiving, by the entitlement server, the hardware/software configuration of the UE; and determining an entitlement status of the UE based on the hardware/software configuration of the UE; and upon determining that the entitlement status is okay, configuring the UE for communicating with the satellite, or, upon determining that the entitlement status is not okay, denying access of the UE to the satellite.

Clause 19. The network of clause 18, wherein the computer-executable instructions that, when executed by the one or more processors, cause the one or more processors to perform operations comprising determining by the mobile network, that the subscription associated with the UE permits access to the satellite further comprises computer-executable instructions that, when executed by the one or more processors, cause the one or more processors to perform operations comprising: receiving a maximum usage level of the satellite of which the UE is allowed to access the satellite; receiving a current usage level of the satellite; and determining that that the current usage level of the satellite is at or lower than the maximum usage level of the satellite.

Clause 20. The network of clause 18, further comprising computer-executable instructions that, when executed by the one or more processors, cause the one or more processors to perform operations comprising revoking access of the UE to the satellite by performing operations comprising: receiving, at the mobile network, a registration request of a second UE requesting access to the satellite; determining by the mobile network, that the subscription associated with the UE is a lower priority access than a second subscription associated with the second UE; and removing access of the UE to the satellite by transferring coverage of the UE to a base station or dropping satellite coverage of the UE.

While the example clauses described above are described with respect to one particular implementation, it should be understood that, in the context of this document, the content of the example clauses can also be implemented via a method, device, system, computer-readable medium, and/or another implementation. Additionally, any of the examples above can be implemented alone or in combination with any other one or more of the other examples.

### Conclusion

Depending on the embodiment, certain operations, acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, components, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks, modules, and components described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Unless otherwise explicitly stated, articles such as “a” or “the” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method, comprising:
receiving, at a mobile network, a registration request of a user equipment (UE) requesting access to a satellite used for communication by the mobile network, wherein the UE has stored thereon an entitlement certificate, the entitlement certificate generated by;
determining, by the mobile network, that a subscription associated with the UE permits access to the satellite;
commencing, by an entitlement server, an entitlement process to determine if the UE is entitled to access the satellite; and
upon determining that the UE is entitled to access the satellite, commencing configuring the UE for communicating with the satellite, or, upon determining that the UE is not entitled to access the satellite, denying access of the UE to the satellite.

2. The method of claim 1, wherein determining by the mobile network, that the subscription associated with the UE permits access to the satellite comprises determining that the subscription includes satellite access.

3. The method of claim 1, wherein determining by the mobile network, that the subscription associated with the UE permits access to the satellite comprises:
receiving a maximum usage level of the satellite of which the UE is allowed to access the satellite;
receiving a current usage level of the satellite; and
determining that that the current usage level of the satellite is at or lower than the maximum usage level of the satellite.

4. The method of claim 1, further comprising revoking access of the UE to the satellite following the determining that the UE is entitled to access the satellite.

5. The method of claim 4, wherein revoking access of the UE to the satellite comprises:
receiving, at the mobile network, a registration request of a second UE requesting access to the satellite;
determining by the mobile network, that the subscription associated with the UE is a lower priority access than a second subscription associated with the second UE; and
removing access of the UE to the satellite by transferring coverage of the UE to a base station or dropping satellite coverage of the UE.

6. The method of claim 5, wherein the second UE is a device used by a first responder.

7. The method of claim 1, further comprising generating an entitlement certificate upon the determining that the UE is entitled to access the satellite, wherein the entitlement certificate is transmitted to the satellite indicating that the UE is entitled to access the satellite.

8. The method of claim 7, further comprising updating, by the entitlement server, the entitlement certificate upon receiving an update of a hardware/software configuration of the UE.

9. The method of claim 1, wherein the entitlement process comprises:
querying an equipment inventory register for a hardware/software configuration of the UE;
receiving, by the entitlement server, the hardware/software configuration of the UE; and
determining an entitlement status of the UE based on the hardware/software configuration of the UE.

10. A non-transitory computer-readable media storing computer-executable instructions that, when executed by one or more processors, cause the one or more processors to perform operations comprising:
receiving, at a mobile network, a registration request of a user equipment (UE) requesting access to a satellite used for communication by the mobile network;
determining, by the mobile network, that a subscription associated with the UE permits access to the satellite; and
commencing, by an entitlement server, an entitlement process to determine if the UE is entitled to access the satellite, the entitlement process comprising:
determining an entitlement status of the UE based on a hardware/software configuration of the UE; and
upon determining that the entitlement status is okay, commencing configuring the UE for communicating with the satellite, or, upon determining that the entitlement status is not okay, denying access of the UE to the satellite.

11. The non-transitory computer-readable media of claim 10, wherein the computer-executable instructions that, when executed by the one or more processors, cause the one or more processors to perform operations comprising determining by the mobile network, that the subscription associated with the UE permits access to the satellite computer-executable instructions that, when executed by the one or more processors, cause the one or more processors to perform operations comprising determining that the subscription includes satellite access.

12. The non-transitory computer-readable media of claim 10, wherein the computer-executable instructions that, when executed by the one or more processors, cause the one or more processors to perform operations comprising determining by the mobile network, that the subscription associated with the UE permits access to the satellite further comprises computer-executable instructions that, when executed by the one or more processors, cause the one or more processors to perform operations comprising:
receiving a maximum usage level of the satellite of which the UE is allowed to access the satellite;
receiving a current usage level of the satellite; and
determining that that the current usage level of the satellite is at or lower than the maximum usage level of the satellite.

13. The non-transitory computer-readable media of claim 10, further comprising revoking access of the UE to the satellite following the determining that the entitlement status is okay.

14. The non-transitory computer-readable media of claim 13, wherein the computer-executable instructions that, when executed by the one or more processors, cause the one or more processors to perform operations comprising revoking access of the UE to the satellite further comprises computer-executable instructions that, when executed by the one or more processors, cause the one or more processors to perform operations comprising:
receiving, at the mobile network, a registration request of a second UE requesting access to the satellite;
determining by the mobile network, that the subscription associated with the UE is a lower priority access than a second subscription associated with the second UE; and
removing access of the UE to the satellite by transferring coverage of the UE to a base station or dropping satellite coverage of the UE.

15. The non-transitory computer-readable media of claim 10, further comprising computer-executable instructions that, when executed by the one or more processors, cause the one or more processors to perform operations comprising generating an entitlement certificate, wherein the entitlement certificate is transmitted to the satellite indicating that the UE is entitled to access the satellite.

16. The non-transitory computer-readable media of claim 15, further comprising computer-executable instructions that, when executed by the one or more processors, cause the one or more processors to perform operations comprising updating, by the entitlement server, the entitlement certificate upon receiving an update of the configuration of the UE.

17. The non-transitory computer-readable media of claim 10, wherein the entitlement process further comprises:
querying an equipment inventory register for the hardware/software configuration of the UE; and
receiving, by the entitlement server, the hardware/software configuration of the UE.

18. A network, comprising:
a memory storing computer-executable instructions; and
one or more processors in communication with the memory, the computer-executable instructions causing the processor to perform acts comprising:
receiving, at a mobile network, a registration request of a user equipment (UE) requesting access to a satellite used for communication by the mobile network;
determining, by the mobile network, that a subscription associated with the UE permits access to the satellite;
commencing, by an entitlement server, an entitlement process to determine if the UE is entitled to access the satellite, the process comprising:
querying an equipment inventory register for a hardware/software configuration of the UE;
receiving, by the entitlement server, the hardware/software configuration of the UE; and
determining an entitlement status of the UE based on the hardware/software configuration of the UE; and
upon determining that the entitlement status is okay, configuring the UE for communicating with the satellite, or, upon determining that the entitlement status is not okay, denying access of the UE to the satellite.

19. The network of claim 18, wherein the computer-executable instructions that, when executed by the one or more processors, cause the one or more processors to perform operations comprising determining by the mobile network, that the subscription associated with the UE permits access to the satellite further comprises computer-executable instructions that, when executed by the one or more processors, cause the one or more processors to perform operations comprising:
receiving a maximum usage level of the satellite of which the UE is allowed to access the satellite;
receiving a current usage level of the satellite; and
determining that that the current usage level of the satellite is at or lower than the maximum usage level of the satellite.

20. The network of claim 18, further comprising computer-executable instructions that, when executed by the one or more processors, cause the one or more processors to perform operations comprising revoking access of the UE to the satellite by performing operations comprising:
receiving, at the mobile network, a registration request of a second UE requesting access to the satellite;
determining by the mobile network, that the subscription associated with the UE is a lower priority access than a second subscription associated with the second UE; and
removing access of the UE to the satellite by transferring coverage of the UE to a base station or dropping satellite coverage of the UE.
